(19) United States
(12) Patent Application Publication
(10) Pub. No.: US 2023/0350755 A1
(43) Pub. Date: Nov. 2, 2023

(54) COORDINATED OPERATING SYSTEM ROLLBACK

(71) Applicant: VMware, Inc., Palo Alto, CA (US)

(72) Inventors: Karthik Ramachandra, Bangalore (IN); Aravinda Haryadi, Bangalore (IN)

(21) Appl. No.: 17/733,201

(22) Filed: Apr. 29, 2022

(51) Int. Cl. G06F 11/14; G06F 9/4401

(52) U.S. Cl. CPC G06F 11/1417; G06F 9/4406; G06F 2201/805

(57) ABSTRACT

Disclosed are various embodiments for coordinating the rollback of installed operating systems to an earlier, consistent state. In response to determining that a data processing unit (DPU) installed on a computing device has failed to successfully boot a first time, the computing device can be power cycled for a first time. In response to determining that the DPU has successfully booted a second time, a first version of a host operating system can be booted. A DPU operating system (DPU OS) is then booted from a DPU alternate boot image. In response to determining that the first version of the host operating system fails to match an executing version of the DPU OS, the computing device can be power cycled a second time and the host operating system is then booted from a host alternate boot image.

### BACKGROUND

Modern computing devices often have dedicated offload cards installed in order to improve the performance or throughput for various tasks. These offload cards can be quite sophisticated, with their own, processors, memory, and operating system. The operating system installed on the offload cards is often synchronized with the operating system installed on the host machine itself. For example, the operating system executing on a host machine might be built from the same version of a source code tree as a complementary operating system installed and executing on an offload card. Accordingly, if the version of the operating system installed on the host machine differs from the version of the operating system installed on the offload card, the two may be incompatible with each other. This can introduce instability into the system and, in extreme cases, render the system as a whole inoperable.

### BRIEF DESCRIPTION OF THE DRAWINGS

Many aspects of the present disclosure can be better understood with reference to the following drawings. The components in the drawings are not necessarily to scale, with emphasis instead being placed upon clearly illustrating the principles of the disclosure. Moreover, in the drawings, like reference numerals designate corresponding parts throughout the several views.

FIG. 1 is a drawing depicting a host machine according to various embodiments of the present disclosure.

FIG. 2 is a sequence diagram illustrating the interactions between the components of the host machine of FIG. 1 according to various embodiments of the present disclosure.

FIG. 3 is a sequence diagram illustrating the interactions between the components of the host machine of FIG. 1 according to various embodiments of the present disclosure.

### DETAILED DESCRIPTION

Disclosed are various approaches for coordinating the rollback of an operating system installed on a host machine. The operating system installed on a host machine or an offload card installed on the host machine can become inoperable or fail to boot. This can happen in a number of situations. For example, an installation of an operating system could become corrupted or damaged. As another example an upgrade or update to the operating system (e.g., a new version), could fail to boot for unexpected reasons. As a result, the bootable version of an operating system installed on a host machine can become unsynchronized with the bootable version of an operating system installed on an offload card.

To resolve these issues, the various embodiments of the present disclosure cause the operating system installed on the host machine and the operating system installed on the offload card to rollback to the previously version. Because the operating system installed on the host machine and the operating system installed on the offload card may need to be the same version, the various embodiments of the present disclosure can cause both operating systems to be rolled back in a coordinated manner, so that the host machine can continue to operate, thereby improving the stability of the operating environment of the host machine.

In the following discussion, a general description of the system and its components is provided, followed by a discussion of the operation of the same. Although the following discussion provides illustrative examples of the operation of various components of the present disclosure, the use of the following illustrative examples does not exclude other implementations that are consistent with the principals disclosed by the following illustrative examples.

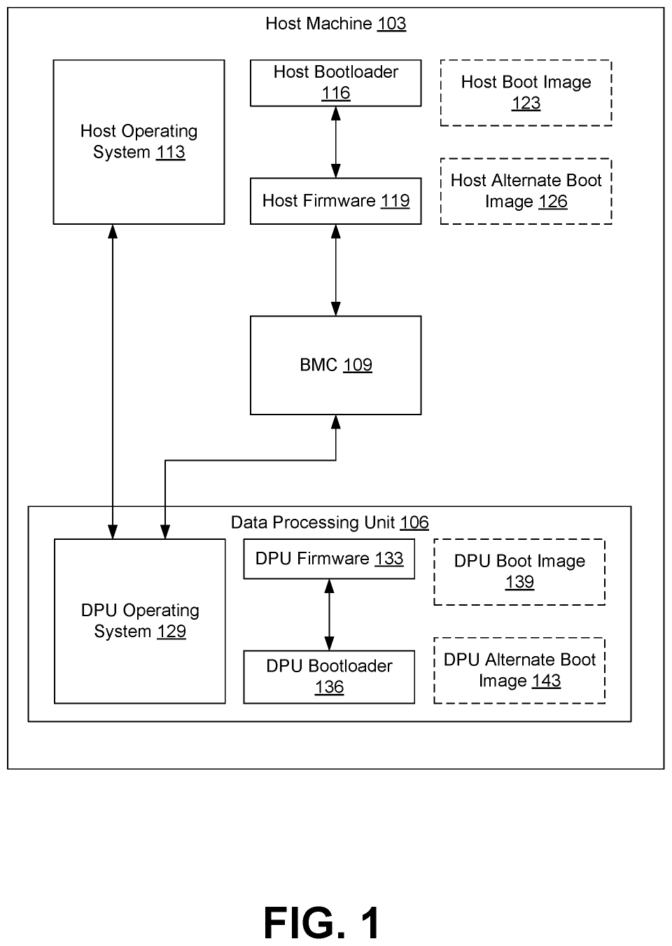

FIG. 1 depicts a host machine 103 according to various embodiments of the present disclosure. The host machine 103 can include one or more processors, a memory, and/or a network interface. The host machine 103 can also include a data processing unit (DPU) 106 and a baseboard management controller (BMC) 109. The host machine 103 can be used to execute various applications or provide various computational resources to third-parties. For example, the host machine 103 could be configured to execute a hypervisor, which could facilitate the execution of one or more guest machines on the host machine 103. Accordingly, in various embodiments, the host machine 103 could execute a host operating system 113, a host bootloader 116, and/or host firmware 119.

The host operating system 113 can include any system software that manages the operation of computer hardware and software resources of the host machine 103. The host operating system 113 can also provide various services or functions to computer programs that are executed by the host machine 103. For example, the host operating system 113 may schedule the operation of tasks or processes by the processor of the host machine 103. The host operating system 113 may also provide virtual memory management functions to allow processes executing on the host machine 103 to have its own logical or virtual address space, which the host operating system 113 can map to physical addresses in the memory of the host machine 103. When referring to the host operating system 113, the host operating system 113 can include both hypervisors and/or any other system software that manages computer hardware and software resources.

The host boot loader 116 can represent a program responsible for booting the host operating system 113 in response to the host machine 103 being powered on. Once execution of the host boot loader 116 is initiated, the bootloader can select either the host boot image 123 or the host alternate boot image 126 to boot the host operating system 113.

The host boot image 123 represents a disk image containing a copy of the current version of the host operating system 113 to be executed by the host machine 103. The host boot image 123 can also include configuration information and state information, such as whether the most recent boot using the host boot image 123 had failed (e.g., which could be indicated by marking the state of the host boot image 123 as “dirty”).

The host alternate boot image 126 can represent a disk image containing a previous version of the host operating system 113 to be executed by the host machine 103. For example, when the host operating system 113 is upgraded to a new version, the previous boot configuration of the host boot image 123 could be saved as the host alternate boot image 126. In the event that the host boot image 123 fails to boot, the host boot loader 116 could attempt to boot the host alternate boot image 126 to return the host operating system 113 to a previous version that is known to be operable.

The host firmware 119 can include software embedded in the host machine 103 to provide a standardized operating environment for more complex software executing on the host machine 103. For example, the PC-compatible Basic Input/Output System (PC-BIOS) used by many desktops, laptops, and servers initializes and tests system hardware components, enables or disables hardware functions as specified in the PC-BIOS configuration, and the loads the host bootloader 116 from memory to initialize the host operating system 113 of the host machine 103. The PC-BIOS also provides a hardware abstraction layer (HAL) for keyboard, display, and other input/output devices which may be used by the host operating system 113 of the host machine 103. The Unified Extensible Firmware Interface (UEFI) provides similar functions as the BIOS, as well as various additional functions such as Secure Boot, a shell environment for interacting with the host machine 103, network connectivity for the host machine 103, and various other functions.

The DPU 106 can represent an offload card installed on the host machine 103 to accelerate the processing of various types of compute workloads. Accordingly, the DPU 106 can include at least one processor, memory, and (in some implementations), one or more network interfaces. DPUs 106 can be used, for example, to accelerate network packet processing (e.g., for a firewall, software defined switch, etc.), input/output operations for local or network storage, or other computational workloads. In other instances, the DPU 106 can be used to execute applications that would typically be executed by the central processor unit (CPU) of the host machine 103, in order to make the resources of the CPU of the host machine 103 available for other tasks. For example, the DPU 106 could execute a hypervisor so that the resources of the CPU of the host machine 103 could be fully dedicated to the guests executing on the host machine 103. Accordingly, in various embodiments, the DPU 106 could execute a DPU operating system 129, a DPU firmware 133, and a DPU bootloader 136.

The DPU operating system 129 can include any system software that manages the operation of computer hardware and software resources of the DPU 106. The DPU operating system 129 can also provide various services or functions to computer programs that are executed by the DPU 106. For example, the DPU operating system 129 may schedule the operation of tasks or processes by the processor of the DPU 106. This could include network packet processing, network packet processing (e.g., for a firewall, software defined switch, etc.), input/output operations for local or network storage, or other computational workloads.

In implementations where the functionality of a hypervisor is implemented by the DPU 106, the DPU operating system 129 may also provide virtual memory management functions to allow processes executing on the host machine 103 to have its own logical or virtual address space, which the DPU operating system 129 can map to physical addresses in the memory of the host machine 103. When referring to the DPU operating system 129, the DPU operating system 129 can include both hypervisors and/or any other system software that manages computer hardware and software resources.

The DPU firmware 133 can include software embedded in the DPU 106 to provide a standardized operating environment for more complex software executing on the DPU 106. For example, the PC-compatible Basic Input/Output System (PC-BIOS) used by many desktops, laptops, and servers initializes and tests system hardware components, enables or disables hardware functions as specified in the PC-BIOS configuration, and the loads the DPU bootloader 136 from memory to initialize the DPU operating system 129 of the DPU 106. The PC-BIOS also provides a hardware abstraction layer (HAL) for keyboard, display, and other input/output devices which may be used by the DPU operating system 129 of the DPU 106. The Unified Extensible Firmware Interface (UEFI) provides similar functions as the BIOS, as well as various additional functions such as Secure Boot, a shell environment for interacting with the DPU 106, network connectivity for the DPU 106, and various other functions.

The DPU bootloader 136 can represent a program responsible for booting the DPU operating system 129 in response to the DPU 106 being powered on. Once execution of the DPU bootloader 136 is initiated, the bootloader can select either the DPU boot image 139 or the DPU alternate boot image 143 to boot the DPU operating system 129.

The DPU boot image 139 represents a disk image containing a copy of the current version of the DPU operating system 129 to be executed by the DPU 106. The DPU boot image 139 can also include configuration information and state information, such as whether the most recent boot using the DPU boot image 139 had failed (e.g., which could be indicated by marking the state of the DPU boot image 139 as “dirty”).

The DPU alternate boot image 143 can represent a disk image containing a previous version of the DPU operating system 129 to be executed by the DPU 106. For example, when the DPU operating system 129 is upgraded to a new version, the previous boot configuration of the DPU boot image 139 could be saved as an DPU alternate boot image 143. In the event that the DPU boot image 139 fails to boot, the DPU boot loader 136 could attempt to boot the DPU alternate boot image 143 to return the DPU operating system 129 to a previous version that is known to be operable.

The BMC 109 represents a specialized microcontroller embedded on the motherboard of the host machine 103 that provides an interface between system management software (such as the host operating system 113 or host firmware 119) and the hardware of the host machine 103. This can include, for example, providing a serial console over a network connection or other out of band communications and control mechanisms for the host machine 103. The BMC 109 can also provide out of band communications channels between hardware components of the host machine 103, such as between the DPU 106 and other components of the host machine 103. In some implementations, the BMC 109 can include its own memory, processor, and optimized embedded firmware.

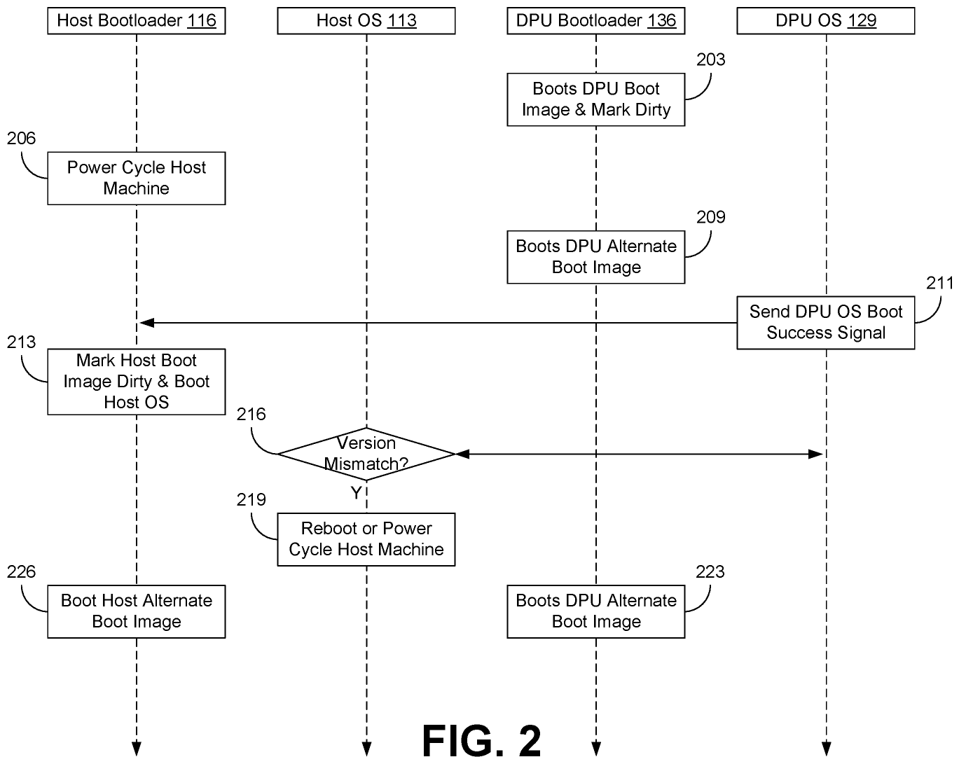

Referring next to FIG. 2, shown is a sequence diagram that provides one example of the interactions between the components of the host machine 103. The sequence diagram of FIG. 2 provides merely an example of the many different types of interactions between the components of the host machine 103 according to the various embodiments of the present disclosure. As an alternative, the sequence diagram of FIG. 2 can be viewed as depicting an example of elements of a method implemented within the host machine 103. As a result of the coordinated reboots depicted in FIG. 2, the host operating system 113 and the DPU operating system 129 can be rolled back to a prior version in response to a failure of the DPU operating system 129 to boot.

Beginning with block 203, the DPU bootloader 136 attempts to boot the DPU operating system 129. Accordingly, the DPU bootloader 136 boots the DPU boot image 139 when the DPU 106 is powered on and begins to boot. Concurrently with booting the DPU boot image 139, the DPU bootloader 136 can mark the DPU boot image 139 as “dirty.” The dirty status can represent that the DPU bootloader 136 has attempted to boot the DPU boot image 139, but a successful boot has yet to occur. If the DPU operating system 129 were to successfully boot from the DPU boot image 139, the DPU bootloader 136 or the DPU operating system 129 could update the status of the DPU boot image 139 to “valid,” or a similar status. To update the status of the DPU boot image 139, the DPU bootloader 136 could update an entry of a configuration file included in the DPU boot image 139.

However, if the DPU operating system 129 fails to successfully boot from the DPU boot image 139, then the host bootloader 116 can cause the host machine 113 to power cycle at block 206. The host bootloader 116 can determine whether the DPU operating system 129 by polling the BMC 109 to determine whether the DPU operating system 129 has sent a ready signal to the BMC 109. Failure to receive a ready signal from the DPU operating system 129 within a predefined period of time could serve as an indicator that the DPU operating system 129 has failed to boot. The power cycle can cause the DPU bootloader 136 to attempt to boot the DPU operating system 129 a second time.

Next, at block 209, the DPU bootloader 136 can attempt to boot the DPU operating system 129 after the power cycle of the host machine 103 is completed. As part of the process, the DPU bootloader 136 can determine that the DPU boot image 139 is currently marked “dirty” (indicating that the DPU operating system 129 had failed to successfully boot from DPU boot image 139 during a previous boot sequence). In response, the DPU bootloader 136 can cause the DPU operating system 129 to boot from the DPU alternate boot image 143.

Referring to block 211, once the DPU operating system 129 boots from the DPU alternate boot image 143, the DPU operating system 129 can send a signal to the host bootloader 116 that the DPU operating system 129 has successfully booted. For example, the DPU operating system 129 could sent a ready signal to the BMC 109, which the host bootloader 116 could read by polling the BMC 109.

In some implementations, the successful boot of the DPU operating system 129 could cause the DPU bootloader 136 or the DPU operating system 129 to mark the DPU alternate boot image as “clean” and to replace the DPU boot image 139 with the DPU alternate boot image 143, effectively making the DPU alternate boot image 143 the current boot image for the DPU operating system 129.

Moving on to block 213, the host bootloader 116 can cause the host operating system 113 to boot in response to receiving the ready signal from the DPU operating system 129 (e.g., because the host bootloader 116 has been polling the BMC 109 to determine that the ready signal has been received from the DPU operating system 129). The host bootloader 116 can mark the host boot image 123 as dirty and then initiate a boot of the host operating system 113 from the host boot image 123.

Proceeding to block 216, the host operating system 113 can determine whether the version of the host operating system 113 that is currently executing matches the version of the DPU operating system 129 that is currently executing. For example, the host operating system 113 could send a request to the DPU operating system 129 for its version identifier (e.g., a version number or build number) and receive the version identifier in response. If the version of the host operating system 113 that is currently executing fails to match the version of the DPU operating system 129 that is currently executing (e.g., because the two operating systems are based off of different builds), then the process proceeds to block 219. However, if the host operating system 113 and the DPU operating system 129 were the same version, the process could end.

Subsequently, at block 219, the host operating system 113 causes the host machine 103 to reboot or power cycle. This can be done to cause the host machine 103 to roll back the host operating system 113 to a version that is the same as, or otherwise synchronized or compatible with, the DPU operating system 129.

Then, at block 223, the DPU operating bootloader 136 can boot the current DPU boot image. This could be either booting the DPU alternate boot image 143 a second time or booting the DPU boot image 139 (which may have been replaced with or written over with the DPU alternate boot image 143). The DPU operating system 129 can then successfully boot from the current boot image.

Next, at block 226, the host boot loader 116 can cause the host operating system 113 to boot from the host alternate boot image 126. Because the host alternate boot image 126 is synchronized with the DPU alternate boot image 143, this can cause the host operating system 113 to successfully boot to a version that matches the currently executing version of the DPU operating system 129. At this point, the rollback of the host operating system 113 and the DPU operating system 129 in response to a failed boot of the DPU operating system 129 is complete.

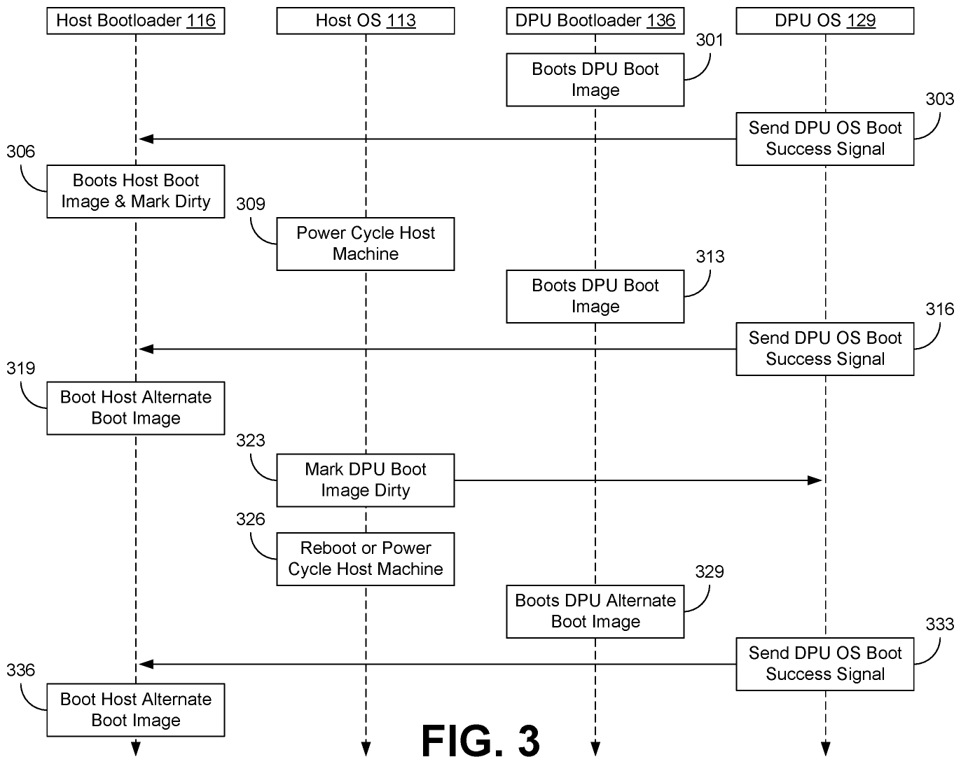

Referring next to FIG. 3, shown is a sequence diagram that provides one example of the interactions between the components of the host machine 103. The sequence diagram of FIG. 3 provides merely an example of the many different types of interactions between the components of the host machine 103 according to the various embodiments of the present disclosure. As an alternative, the sequence diagram of FIG. 3 can be viewed as depicting an example of elements of a method implemented within the host machine 103. As a result of the coordinated reboots depicted in FIG. 3, the host operating system 113 and the DPU operating system 129 can be rolled back to a prior version in response to a failure of the host operating system 113 to boot.

Beginning with block 301, the DPU bootloader 136 can boot the DPU operating system 129, which can occur when the DPU 106 is powered on. Concurrently with booting the DPU boot image 139, the DPU bootloader 136 can mark the DPU boot image 139 as “dirty.” The dirty status can represent that the DPU bootloader 136 has attempted to boot the DPU boot image 139, but a successful boot has yet to occur. After the DPU operating system 129 successfully boots from the DPU boot image 139, the DPU bootloader 136 or the DPU operating system 129 can update the status of the DPU boot image 139 to “valid,” or a similar status. To update the status of the DPU boot image 139, the DPU bootloader 136 could update an entry of a configuration file included in the DPU boot image 139. Once the DPU operating system 129 successfully boots from the DPU boot image 139, then at block 303 the DPU operating system 129 can send a signal to the host bootloader 116 that the DPU operating system 129 has successfully booted. For example, the DPU operating system 129 could sent a ready signal to the BMC 109, which the host bootloader 116 could read by polling the BMC 109.

Then, at block 306, the host bootloader 116 can cause the host operating system 113 to boot in response to receiving the ready signal from the DPU operating system 129 (e.g., because the host bootloader 116 has been polling the BMC 109 to determine that the ready signal has been received from the DPU operating system 129). Concurrently with booting the host boot image 123, the host bootloader 116 can mark the host boot image 123 as “dirty.” The dirty status can represent that the host bootloader 116 has attempted to boot the host boot image 123, but a successful boot has yet to occur. If the host operating system 113 were to successfully boot, then the host bootloader 116 or the host operating system 113 could update the status of the host boot image 123 to “valid,” or a similar status.

However, at block 309, the host operating system 113 can cause the host machine 113 to power cycle in response to a failed boot. For example, the boot sequence or system of the host operating system 113 could detect that one or more services had failed to load or start, and therefore the boot of the host operating system 113 had failed. However, in some instances, the boot failure may occur in such a manner that the host operating system 113 freezes and is unable to cause the host machine 103 to perform a power cycle. In these instances, manual or external intervention may be required to cause the host machine 103 to power cycle.

After the host machine 103 power cycles, then the DPU bootloader 136 can boot the DPU operating system 129 from the DPU boot image 139, which had been previously marked as a “valid” boot image at block 303. Once the DPU operating system 129 successfully boots from the DPU boot image 139, then at block 316 the DPU operating system 129 can send a signal to the host bootloader 116 that the DPU operating system 129 has successfully booted. For example, the DPU operating system 129 could sent a ready signal to the BMC 109, which the host bootloader 116 could read by polling the BMC 109.

Proceeding to block 319, the host bootloader 116 can cause the host operating system 113 to boot in response to receiving the ready signal from the DPU operating system 129 (e.g., because the host bootloader 116 has been polling the BMC 109 to determine that the ready signal has been received from the DPU operating system 129). As the host bootloader 116 had previously marked the host boot image 123 as dirty at block 306, the host boot loader 116 at block 319 can determine that the host boot image 123 is marked dirty and, instead, boot the host operating system 113 from the host alternate boot image 126. However, in some implementations, the host bootloader 116 could replace the host boot image 123 with the host alternate boot image 126 at block 319 to simplify subsequent boots.

Subsequently, at block 323, the host operating system 323 can mark the DPU boot image 139 as “dirty” after the host operating system 113 has successfully booted from the host alternate boot image 126. For example, the host operating system 113 could send a message to the DPU operating system 129 to mark the DPU boot image 139 as “dirty.” The DPU operating system 129 could, in turn, update the status of the DPU boot image 139 to “dirty.”

Next, at block 326, the host operating system 113 can cause the host machine 113 to power cycle or reboot. This can be done to in an attempt to boot the host machine 103 to a state where both the host operating system 113 and the DPU operating system 129 boot with the same version identifier (e.g., a version number or build number).

Then, at block 329, the DPU boot loader 136 can cause the DPU operating system 129 to boot from the DPU alternate boot image 143. For example, the DPU boot loader 136 could note that the DPU boot image 139 is currently indicated as “dirty.” In response, the DPU boot loader 136 could then boot the DPU operating system 129 from the DPU alternate boot image 143. Once the DPU operating system 129 boots from the DPU alternate boot image 143, then at block 333 the DPU operating system 129 can send a signal to the host bootloader 116 that the DPU operating system 129 has successfully booted.

Moving on to block 336, the host bootloader 116 can cause the host operating system 113 to boot in response to receiving the ready signal from the DPU operating system 129 (e.g., because the host bootloader 116 has been polling the BMC 109 to determine that the ready signal has been received from the DPU operating system 129). As the host bootloader 116 had previously marked the host boot image 123 as dirty at block 306, the host boot loader 116 at block 319 can determine that the host boot image 123 is marked dirty and, instead, boot the host operating system 113 from the host alternate boot image 126. However, if the host bootloader 116 had, at block 319, replaced the host boot image 123 with the host alternate boot image 126, then the host bootloader 116 could boot the updated host boot image 123 instead.

A number of software components previously discussed are stored in the memory of the respective computing devices and are executable by the processor of the respective computing devices. In this respect, the term “executable” means a program file that is in a form that can ultimately be run by the processor. Examples of executable programs can be a compiled program that can be translated into machine code in a format that can be loaded into a random access portion of the memory and run by the processor, source code that can be expressed in proper format such as object code that is capable of being loaded into a random access portion of the memory and executed by the processor, or source code that can be interpreted by another executable program to generate instructions in a random access portion of the memory to be executed by the processor. An executable program can be stored in any portion or component of the memory, including random access memory (RAM), read-only memory (ROM), hard drive, solid-state drive, Universal Serial Bus (USB) flash drive, memory card, optical disc such as compact disc (CD) or digital versatile disc (DVD), floppy disk, magnetic tape, or other memory components.

The memory includes both volatile and nonvolatile memory and data storage components. Volatile components are those that do not retain data values upon loss of power. Nonvolatile components are those that retain data upon a loss of power. Thus, the memory can include random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, or other memory components, or a combination of any two or more of these memory components. In addition, the RAM can include static random access memory (SRAM), dynamic random access memory (DRAM), or magnetic random access memory (MRAM) and other such devices. The ROM can include a programmable read-only memory (PROM), an erasable programmable read-only memory (EPROM), an electrically erasable programmable read-only memory (EEPROM), or other like memory device.

Although the applications and systems described herein can be embodied in software or code executed by general purpose hardware as discussed above, as an alternative the same can also be embodied in dedicated hardware or a combination of software/general purpose hardware and dedicated hardware. If embodied in dedicated hardware, each can be implemented as a circuit or state machine that employs any one of or a combination of a number of technologies. These technologies can include, but are not limited to, discrete logic circuits having logic gates for implementing various logic functions upon an application of one or more data signals, application specific integrated circuits (ASICs) having appropriate logic gates, field-programmable gate arrays (FPGAs), or other components, etc. Such technologies are generally well known by those skilled in the art and, consequently, are not described in detail herein.

The flowcharts and sequence diagrams show the functionality and operation of an implementation of portions of the various embodiments of the present disclosure. If embodied in software, each block can represent a module, segment, or portion of code that includes program instructions to implement the specified logical function(s). The program instructions can be embodied in the form of source code that includes human-readable statements written in a programming language or machine code that includes numerical instructions recognizable by a suitable execution system such as a processor in a computer system. The machine code can be converted from the source code through various processes. For example, the machine code can be generated from the source code with a compiler prior to execution of the corresponding application. As another example, the machine code can be generated from the source code concurrently with execution with an interpreter. Other approaches can also be used. If embodied in hardware, each block can represent a circuit or a number of interconnected circuits to implement the specified logical function or functions.

Although the flowcharts and sequence diagrams show a specific order of execution, it is understood that the order of execution can differ from that which is depicted. For example, the order of execution of two or more blocks can be scrambled relative to the order shown. Also, two or more blocks shown in succession can be executed concurrently or with partial concurrence. Further, in some embodiments, one or more of the blocks shown in the flowcharts and sequence diagrams can be skipped or omitted. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein that includes software or code can be embodied in any non-transitory computer-readable medium for use by or in connection with an instruction execution system such as a processor in a computer system or other system. In this sense, the logic can include statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. Moreover, a collection of distributed computer-readable media located across a plurality of computing devices (e.g, storage area networks or distributed or clustered filesystems or databases) may also be collectively considered as a single non-transitory computer-readable medium.

The computer-readable medium can include any one of many physical media such as magnetic, optical, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium can be a random access memory (RAM) including static random access memory (SRAM) and dynamic random access memory (DRAM), or magnetic random access memory (MRAM). In addition, the computer-readable medium can be a read-only memory (ROM), a programmable read-only memory (PROM), an erasable programmable read-only memory (EPROM), an electrically erasable programmable read-only memory (EEPROM), or other type of memory device.

Further, any logic or application described herein can be implemented and structured in a variety of ways. For example, one or more applications described can be implemented as modules or components of a single application. Further, one or more applications described herein can be executed in shared or separate computing devices or a combination thereof. For example, a plurality of the applications described herein can execute in the same computing device, or in multiple computing devices in the same computing environment.

Disjunctive language such as the phrase “at least one of X, Y, or Z,” unless specifically stated otherwise, is otherwise understood with the context as used in general to present that an item, term, etc., can be either X, Y, or Z, or any combination thereof (e.g., X; Y; Z; X or Y; X or Z; Y or Z; X, Y, or Z; etc.). Thus, such disjunctive language is not generally intended to, and should not, imply that certain embodiments require at least one of X, at least one of Y, or at least one of Z to each be present.

It should be emphasized that the above-described embodiments of the present disclosure are merely possible examples of implementations set forth for a clear understanding of the principles of the disclosure. Many variations and modifications can be made to the above-described embodiments without departing substantially from the spirit and principles of the disclosure. All such modifications and variations are intended to be included herein within the scope of this disclosure and protected by the following claims.

Therefore, the following is claimed:

1. A system, comprising:
a computing device comprising a central processor unit (CPU) and a data processing unit (DPU);
a first set of machine-readable instructions that, when executed by the CPU, cause the computing device to at least:
in response to a first determination that the DPU has failed to successfully boot a first time, cause the computing device to power cycle a first time;
in response to a second determination that the DPU has successfully booted a second time, cause a first version of a host operating system to boot; and
in response to a third determination that the first version of the host operating system fails to match an executing version of a DPU operating system (DPU OS), cause the computing device to power cycle a second time; and
in response to the computing device power cycling the second time, cause the host operating system to boot from a host alternate boot image; and
a second set of machine-readable instructions stored in the memory that, when executed by the DPU, cause the DPU to at least:
determine that a DPU boot image is marked as dirty; and
in response to fourth determination that the DPU boot image is dirty, cause the DPU OS to boot from a DPU alternate boot image, wherein the version of the host operating system booted from the host alternate boot image matches the version of the DPU OS booted from the DPU alternate boot image.

2. The system of claim 1, wherein the first set of machine-readable instructions further cause the computing device to at least determine that the DPU has failed to successfully boot the first time based at least in part on a failure to receive a DPU OS boot success signal within a predefined period of time after the computing device boots.

3. The system of claim 2, wherein the first set of machine-readable instructions further cause the computing device to at least determine that the DPU OS boot success signal has failed to be received by polling a baseboard management controller (BMC) to determine that the BMC has failed to receive the DPU OS boot success signal within the predefined period of time after the computing device boots.

4. The system of claim 1, wherein the second set of machine-readable instructions further cause the DPU to at least mark the DPU boot image as dirty when the DPU boots the first time.

5. The system of claim 1, wherein the first set of machine-readable instructions further cause the computing device to at least:
send a request to the DPU OS for a first version identifier, the first version identifier representing the executing version of the DPU OS;
compare the first version identifier to a second version identifier, the second version identifier representing the first version of the host operating system; and
determine that the first version of the host operating system fails to match the executing version of the DPU OS based at least in part on a comparison of the first version identifier with the second version identifier.

6. The system of claim 1, wherein the second set of machine-readable instructions further cause the DPU to at least send a DPU OS boot success signal to a baseboard management controller (BMC).

7. The system of claim 1, wherein the DPU is an offload card installed in the computing device.

8. A method, comprising:
in response to determining that a data processing unit (DPU) installed on a computing device has failed to successfully boot a first time, power cycling the computing device for a first time;
in response to determining that the DPU has successfully booted a second time, booting a first version of a host operating system;
determining that a DPU boot image is marked as dirty; and
in response to determining that the DPU boot image is dirty, booting a DPU operating system (DPU OS) from a DPU alternate boot image.
in response to determining that the first version of the host operating system fails to match an executing version of the DPU OS, power cycling the computing device a second time; and
in response to the computing device power cycling the second time, booting the host operating system from a host alternate boot image, wherein the version of the host operating system booted from the host alternate boot image matches the version of the DPU OS booted from the DPU alternate boot image.

9. The method of claim 8, further comprising determining that the DPU has failed to successfully boot the first time based at least in part on a failure of a baseboard management controller (BMC) to receive a DPU OS boot success signal within a predefined period of time after the computing device boots.

10. The method of claim 9, further comprising by polling a baseboard management controller (BMC) to determine that the BMC has failed to receive the DPU OS boot success signal within the predefined period of time after the computing devices boots

11. The method of claim 8, further comprising marking the DPU boot image as dirty when the DPU boots the first time.

12. The method of claim 8, wherein determining that the first version of the host operating system fails to match the executing version of the DPU OS further comprises:
sending a request to the DPU OS for a first version identifier, the first version identifier representing the executing version of the DPU OS;
comparing the first version identifier to a second version identifier, the second version identifier representing the first version of the host operating system; and
determining that the first version of the host operating system fails to match the executing version of the DPU OS based at least in part on a comparison of the first version identifier with the second version identifier.

13. The method of claim 8, further comprising sending a DPU OS boot success signal to a baseboard management controller (BMC).

14. The method of claim 8, wherein the DPU is an offload card installed in the computing device.

15. A plurality of non-transitory, computer-readable mediums, comprising
a first non-transitory, computer-readable medium, comprising a first set of machine-readable instructions that, when executed by a central processing unit (CPU) of a computing device, cause the computing device to at least:
in response to a first determination that a data processing unit (DPU) of the computing device has failed to successfully boot a first time, cause the computing device to power cycle a first time;
in response to a second determination that the DPU has successfully booted a second time, cause a first version of a host operating system to boot; and
in response to a third determination that the first version of the host operating system fails to match an executing version of a DPU operating system (DPU OS), cause the computing device to power cycle a second time; and
in response to the computing device power cycling the second time, cause the host operating system to boot from a host alternate boot image; and
a second non-transitory, computer-readable medium, comprising a second set of machine-readable instructions that, when executed by the DPU of the computing device, cause the DPU to at least:
determine that a DPU boot image is marked as dirty; and
in response to fourth determination that the DPU boot image is dirty, cause the DPU OS to boot from a DPU alternate boot image, wherein the version of the host operating system booted from the host alternate boot image matches the version of the DPU OS booted from the DPU alternate boot image.

16. The non-transitory, computer-readable medium of claim 15, wherein the first set of machine-readable instructions further cause the computing device to at least determine that the DPU has failed to successfully boot the first time based at least in part on a failure to receive a DPU OS boot success signal within a predefined period of time after the computing device boots.

17. The non-transitory, computer-readable medium of claim 16, wherein the first set of machine-readable instructions further cause the computing device to at least determine that the DPU OS boot success signal has failed to be received by polling a baseboard management controller (BMC) to determine that the BMC has failed to receive the DPU OS boot success signal within the predefined period of time after the computing device boots.

18. The non-transitory, computer-readable medium of claim 15, wherein the second set of machine-readable instructions further cause the DPU to at least mark the DPU boot image as dirty when the DPU boots the first time.

19. The non-transitory, computer-readable medium of claim 15, wherein the first set of machine-readable instructions further cause the computing device to at least:
send a request to the DPU OS for a first version identifier, the first version identifier representing the executing version of the DPU OS;
compare the first version identifier to a second version identifier, the second version identifier representing the first version of the host operating system; and
determine that the first version of the host operating system fails to match the executing version of the DPU OS based at least in part on a comparison of the first version identifier with the second version identifier.

20. The non-transitory, computer-readable medium of claim 15, wherein the second set of machine-readable instructions further cause the DPU to at least send a DPU OS boot success signal to a baseboard management controller (BMC).
